(19) United States
(12) Patent Application Publication
(10) Pub. No.: US 2017/0228409 A1
(43) Pub. Date: Aug. 10, 2017

(54) IN-MEMORY JOURNALING

(71) Applicant: Red Hat, Inc., Raleigh, NC (US)

(72) Inventors: Jeffrey Jon Darcy, Lexington, MA (US); Avra Sengupta, Orissa (IN)

(21) Appl. No.: 15/018,022

(22) Filed: Feb. 8, 2016

(51) Int. Cl. G06F 17/30; G06F 11/14

(52) U.S. Cl. CPC G06F 17/30368; G06F 17/30091; G06F 11/1474; G06F 2201/87

(57) ABSTRACT

Systems and methods for indexing and searching an event log to determine whether an object of a file system is current. An example method may comprise: arranging a plurality of events into multiple segments, the plurality of events comprising operations affecting a plurality of objects; generating multiple indexes in view of the one or more segments, the indexes comprising a composite index representing the plurality of objects modified by the plurality of events; and inspecting the composite index to determine an object of the plurality of objects is modified by at least one of the plurality of events.

### TECHNICAL FIELD

The present disclosure generally relates to a journal that stores changes to commit to a data store, and more specifically relates to a journaling data store that includes one or more indexes that indicate when an object within the data store is associated with changes that have not yet been committed.

### BACKGROUND

Modern computers include data stores to store and organize data. A data store receives change requests and processes the change requests to update the data residing in the data store. Often there is a delay between the time a change request is received and the time the change request is committed to the data store. The delay may result in a mismatch between the data in the data store after the change request is committed and the data in the data store at the current point in time (e.g., stale data).

While the data store is receiving change requests, it may also be receiving access requests to provide data at specific locations. The data store may fulfill the access request using the stale data residing at the specific location and may not be aware there is an impending change request being processed.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a high-level diagram of an example system architecture in accordance with one or more aspects of the present disclosure;

FIG. 2 depicts a high-level diagram of an example data storage computing device in accordance with one or more aspects of the present disclosure;

FIG. 3 depicts a flow diagram of an example method for arranging and indexing events to determine which objects are modified by the events in an event log in accordance with one or more aspects of the present disclosure;

FIG. 4 depicts a flow diagram of an example method for receiving events and generating an index that may be used to retrieve data for the objects from a file system's datastore and event log in accordance with one or more aspects of the present disclosure;

FIG. 5 depicts a block diagram of a computer system operating in accordance with one or more aspects of the present disclosure.

### DETAILED DESCRIPTION

Described herein are methods and systems for providing an in-memory journal that indexes an event log and retrieves data for an object within a data store. A data store may be a file system that includes structures and rules for storing and managing objects, and an object may be a file system object such as a file or a portion of a file. The in-memory journal may provide a view of a data store that takes into account impending changes that have not been committed to the data store and may help minimize the retrieval of stale data. The in-memory journal may be formed by analyzing events for a data store that have been stored in an event log. Each event may correspond to an operation, transaction or other action that affects objects within the data store. The event log may be analyzed to create one or more indexes that indicate whether an object within the data store includes data that is out of date. Each index may represent the objects (e.g., files or file blocks) that have been affected by an event within the event log. For example, the index may span multiple objects within the data storage and may indicate which objects have changed. The index may be a hash data structure or probabilistic data structure and may include the identifiers of objects that have been altered by one or more of the events. In one example, the indexes may be Bloom filters that store a set of altered objects and can be inspected to determine whether a specified object was altered. A Bloom filter may include a bit array and one or more hash functions to store items within a set in a spatially efficient manner. The Bloom filter may be inspected to determine whether an item is within the set and may indicate whether the item is “probably in the set” or “definitely not in the set.”

In one example, the in-memory journaling may be embedded within a journaling file system and may include multiple segment Bloom filters and a composite Bloom filter for determining whether an object was modified by events in a journal. The segment Bloom filters may each correspond a portion of an event log, such as a specific time period. The composite Bloom filter may be derived from the segment Bloom filters and may span the combined duration of time represented by the multiple segment Bloom filters. Each of the Bloom filters may be probabilistic data structures that may indicate whether an object is “probably modified” or “definitely not modified.” When the composite Bloom filter indicates an object is “probably modified,” one or more of the segment Bloom filters may be inspected to identify which segment of the event log includes the event that will modify the object. If none of the segment Bloom filters indicate the object was modified, the in-memory journaling may determine the object in the data store is up-to-date and retrieve the data from the data store. If one of the segment Bloom filters indicates the file system object was modified, the in-memory journaling may identify the event within the segment and retrieve the new data from the event. The in-memory journaling may be advantageous because it may enable a device to more quickly identify when data within a data store is out of date and to retrieve more current data from the event log.

Systems and methods described herein include a journaling data store with an in-memory journaling feature. Various aspects of the above referenced methods and systems are described in details herein below by way of examples, rather than by way of limitation.

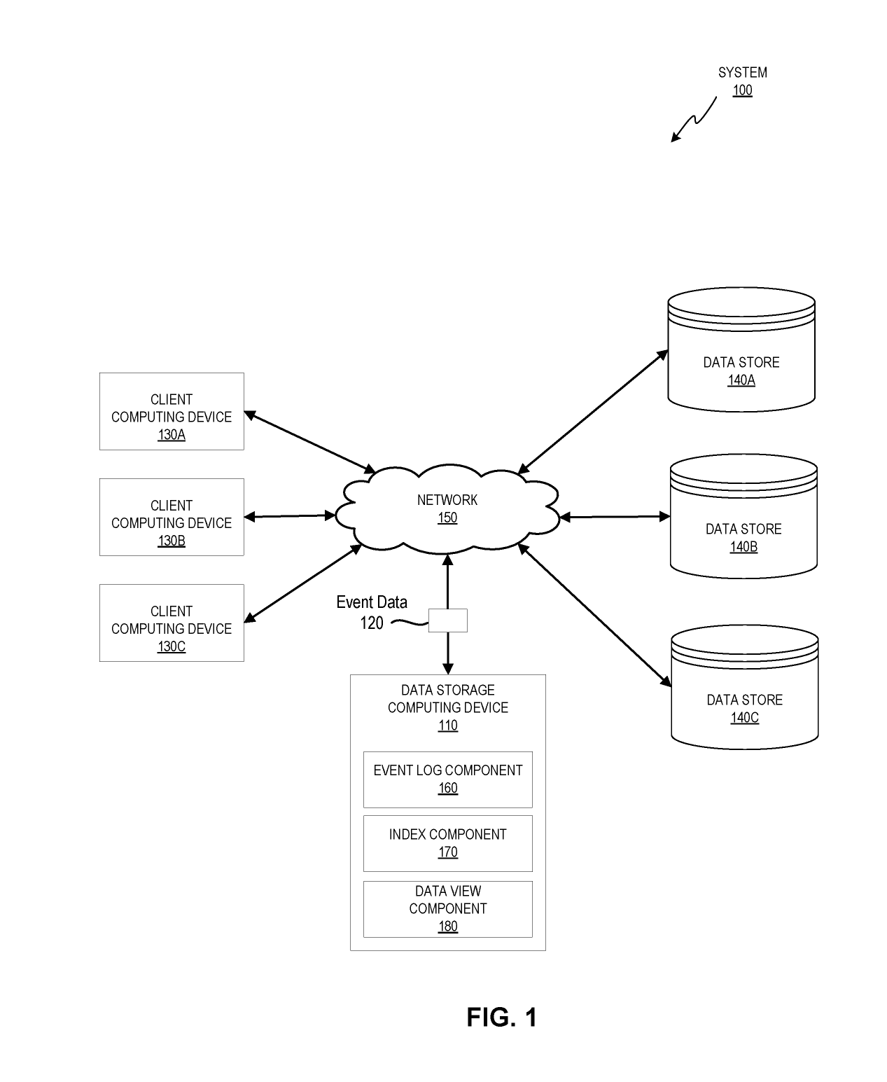

FIG. 1 illustrates an example system 100, in accordance with an implementation of the disclosure. The system may include data storage computing device 110, event data 120, client computing devices 130A-C, data stores 140A-C and a network 150.

Data storage computing device 110 may manage one or more data stores 140A-C and may store and process event data 120 received from client computing device 130A-C. Data storage computing device 110 may include an event log component 160, an index component 170, and a data view component 180. Event log component 160 may receive event data 120 and may store the event data in an event log (e.g., journal log). Event log component 160 may also segment the event log into smaller portions for subsequent analysis. Index component 170 may analyze the segments of the event log and may generate multiple indexes. Data view component 180 may use the event log and the indexes to determine data that corresponds to specified objects within the data store.

Client computing devices 130A-C may include computing devices that communicate with data storage computing device 110 to access or modify one or more objects on data stores 140A-C. Each of the computing devices 130A-C may initiate modifications to the objects stored on the data stores 140A-C via direct or indirect communication (e.g., network access). Computing devices 130A-C may initiate event requests to access, create, or delete objects which may be transferred to data store 140 in the form of event data 120.

Event data 120 may include operations and data associated with the operations. The operations may include transactions, commands or other actions that may affect data within a data store. In one example, the operations may include a write operation, a rename operation, an object creation operation, an object deletion operation, a rename operation, a permission alteration operation or any other operation or combination of operations. The operation may be associated with data that may be the subject of the operation. For example, event data may include a write operation that includes data to be written in the form of binary or textual data. The data may be added, replaced, or removed from an object or be associated with a change to an objects metadata (e.g., permissions, name, location). Event data 120 may include external events that are external to data storage computing device 110 and are received from an external source (e.g., client computing device 130) or may be internal events that are internal to data storage computing device 110 such as events associated with an existing request or that represent a change in a state (e.g., received, processed, committed).

Event data 120 may include synchronization event data for synchronizing one or more data stores 140A-C. In one example, data stores 140A-C may be related or derived from one another or from a common original data store and may include replicated data stores. A replicated data store may be synchronized with one or more other data stores and may include cloned data stores, mirrored data stores, copied data stores, synced data stores or other related data stores. The synchronization may be two-way synchronization wherein events affecting a first data store are transmitted and applied to a second data store and events affecting the second data store may be transmitted and applied to the first data store. Synchronization may be advantageous because it may enable a data store to be replicated and kept in sync as one or more of the replicated data stores are changed by different sources. The synchronization may also be one-way synchronization wherein events to a first data store are transmitted and applied to a second data store but no events (e.g., changes) are transmitted from the second data store to the first data store. This may be advantageous when generating a replica data store that is used as a backup replica or a test replica.

Data stores 140A-C may each include structures and rules for managing data and may utilize one or more data storage resources to store data. The data storage resources may include disk storage, tape storage, optical storage, flash storage, or other type of storage or combination thereof. The data may be arranged to form one or more objects. The objects may include portions of files, directories, metadata and other information used by the data storage to store, manage, or organize data. In one example, data stores 140A-C may include journaling files systems and the objects may be file system objects.

Data stores 140A-C may be local data stores that utilize data storage that may be directly attached to the computing device or may be distributed data stores. Directly attached data storage may be storage that is accessible to a computing device without traversing a network connection. Data stores 140A-C may include a structure that has both the metadata (e.g., i-nodes) and data of a file stored on the same data storage computing device or may store the metadata on one data storage computing device and the corresponding data on a different data storage computing device. Data storages 140A-C may include one or more file systems which may be the same or similar to a Unix File System (UFS), a Global File System (GFS), a New Technology Files System (NTFS), a Hierarchical File System (HFS), a Zettabyte File System, an Extended File System (EFS) or other file system or variation. Data stores 140A-C may be accessed by computing devices 130A and 130B using a communication channel, which may be the same or similar to Fibre Channel, Small Computer System Interface (SCSI), Universal Serial Bus (USB), Thunderbolt, Enhanced Integrated Drive Electronics (EIDE) or other interface technology.

Data store 140A-C may also be distributed data stores that may span multiple computing devices and may be accessed by computing devices 130A-C by traversing one or more networks. A distributed data store may include multiple data storage nodes that may function together to create, store, and remove file system objects. Data store 140A-C may have decentralized management, centralized management or a combination of both (e.g., hierarchical).

Decentralized management may include a data store that has more than one node managing the data storage activities of data storage nodes 114. Centralized management may include a distributed data store where one of the nodes manages the data storage activities of some or all of the other nodes. Data store 140A-C may also have a partially centralized and partially decentralized management. For example, there may be an arrangement that includes multiple nodes arranged in a hierarchical arrangement (e.g., tree or star storage topology) such that a top-level node manages mid-level nodes and the mid-level nodes manage lower-level nodes.

Network 150 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, and/or various combinations thereof.

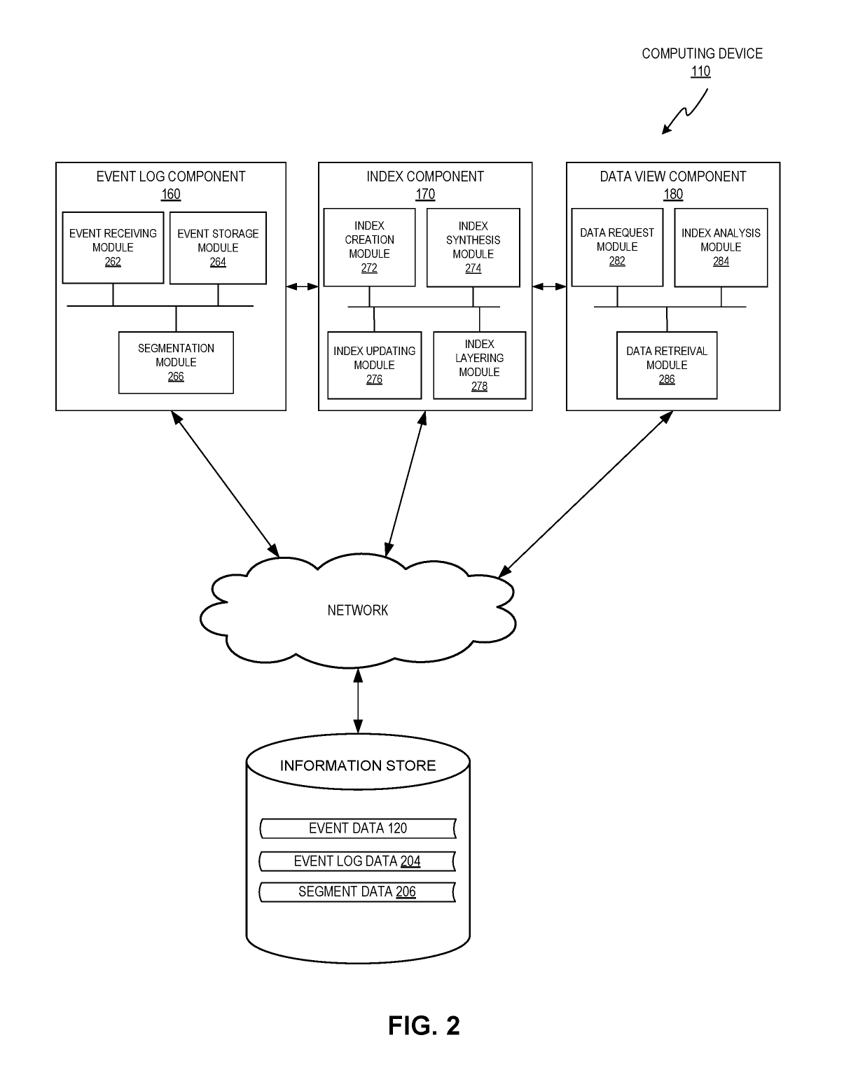

FIG. 2 illustrates an example data storage computing device 110 in accordance with an implementation of the disclosure. As discussed above, data storage computing device 110 may include an event log component 160, an index component 170 and a data view component 180. Event log component 160 may include an event receiving module 262, an event storage module 264 and a segmentation module 266. Index component 170 may include an index creation module 272, an index synthesis module 274, an index updating module 276, and an index layering module 278. Data view component 180 may include a data request module 282, an index analysis module 284 and a data retrieval module 286.

Event log component 160 may receive and store event data 120 in an event log (e.g., journal) and may arrange the event data 120 into segments for subsequent analysis. Event log component 160 may include an event receiving module 262 that receives event data from one or more computing devices. Event data may be in the form of individual events, streams of events or a combination thereof. Individual events may include one or more messages that may indicate the operation and data associated with the event. A stream of events may be in the form of an event stream that includes multiple events from the same source or different sources (e.g., multiple replicas).

Event storage module 264 may receive events from event receiving module 262 and may record the events in one or more event logs 204. An event log may be a data structure that stores one or more events before, during, or after the events are processed. The data structure may be a queue, a circular log and may include one or more arrays, lists, or a combination thereof. The event log may be stored in volatile storage (e.g., memory) or non-volatile storage (e.g., flash storage, disk storage). In one example, the event log may include events that modify a first data store and the event log may be stored (e.g., persisted) within a portion of the same data store (i.e., first data store). In another example, the event log may include events that modify the first data store but the event log may be stored in a second data store (e.g., memory, flash storage) without being stored in the first data store. In one embodiment, the event log may be a journal log that stores events that alter file system objects. In another embodiment, the event log may be a transaction log for a database and may store events that alter database objects.

Event storage module 264 may generate multiple event logs for organizing the events. For example, when multiple replicated data stores (e.g., replicas) are involved there may be one or more event logs for each of the replicated data stores (e.g., local replica and other replica), which may include an event log with outgoing events and event log with incoming events. Outgoing events may represent changes to the local replica and may be sent by the computing device 110 to update one or more other replicas. Incoming events may represent changes to the one or more other replicas and may be received by the computing device and applied to the local replica. In one example, a single event log may be stored as multiple log files. A first log file may be a consolidated log file including an entry for each event and the entry may include a portion of an event (e.g., write operation) and a reference to a second log file comprising a remaining portion of the event such as the data corresponding to the operation (e.g., text to be written).

Segmentation module 266 may analyze and arrange event data 120 of event log 204 into one or more segments. Each segment may correspond to a duration of time and may include one or more events. The quantity of segments and the quantity of events within each segment may vary and may be customized by a product designer, IT administrator, user or any other person. In one example, a new segment may be generated when a threshold period of time has elapsed (e.g., one or more seconds, minutes, hours). In another example, a new segment may be generated when the events within a segment meet or exceed a threshold. The threshold may be based on an event quantity (e.g., 10 k, 100 k), an event storage capacity (e.g., one or more Gigabytes or Terabytes), or other threshold or combination of thresholds. In yet another example, the segments may correspond to a term of a member of a computing device group (e.g., server group, cluster). The member may be a computing device that has been elected or assigned a leadership function (e.g., leader), which may involve assigning tasks or jobs to one or more of the other members of the computing device group. In the latter example, a new segment may be generated when membership changes, leadership changes amongst the members or when the current leader obtains a new lease (e.g., new term).

Data storage computing device 110 may also include an index component 170 that may analyze the event logs and may generate one or more indexes that represent the objects affected by the events. Index component 170 may include index creation module 272, index synthesis module 274, index updating module 276, and index layering module 278.

Index creation module 272 may analyze the events within the event log and create one or more indexes. The indexes may represent objects or locations within a data store and may indicate whether the objects or locations have been affected (or unaffected) by an event within the event log. The index may be a probabilistic data structure that may be used to determine whether an object is a member of a set. The probabilistic data structure may provide false positive matches without providing any false negative matches and may therefore indicate whether an object is “possibly in the set” or “definitely not in the set.” Use of a probabilistic data structure may be advantageous because it may be a spatially-efficient and a processing-efficient mechanism for storing the set of objects that have been modified by events within the event log.

The probabilistic data structure may be implemented using one or more flag storage structures (e.g., bit arrays) and one or more functions (e.g., hash functions). Each function may map or hash an object to one or more positions within the flag storage structure according to a statistical distribution (e.g., uniform random distribution). Adding an object to the probabilistic data structure may involve providing an object's identification data (e.g., file identifier, block identifier) to each of the functions to identify one or more positions in the flag storage structure and flagging these positions (e.g., setting bit in a bit array). As objects are added to the set, there is an increased probability of false positives, which may indicate the object is within the set when the object was not actually added to the set. In one example, the probabilistic data structure may enable the addition of objects but may not enable the removal of the objects or any object. When removal of an object is intended, the probabilistic data structure may be re-generated or a new probabilistic data structure may be created without including the identifier(s) that are intended to be removed. In one embodiment, one or more of the indexes may be Bloom filters or cuckoo hashes or other similar structures.

Index creation module 272 may analyze event log 204 and segment data 206 to create an index for each segment. Creating an index for a segment may involve the index creation module 272 analyzing the events associated with a segment to determine which objects are altered and adding each of the altered objects to the index. In one example, this may involve iterating through each event to determine identification information for the object being altered and adding the identification information to the index

Index synthesis module 274 may combine one or more indexes to produce a composite index. Combining indexes may involve merging, synthesizing, copying, hiding or deleting portions of the indexes to generate a new composite index. The composite index may correspond to a duration, granularity or scope that is the same or different from the one or more indexes it is derived from. The duration of an index may correspond to the duration of time of the segments that the index represents. When multiple segment indexes from different durations of time are combined the resulting composite index may cover the combined durations of time and therefore the composite index may have a broader duration (e.g., cover a larger span of time). The scope of an index may correspond to the portion of a data store represented by the index, such as the quantity of objects or quantity of storage locations. The granularity of an index may correspond to the level of detail represented by the index. For example, a composite index may represent objects at a file system object level (e.g., File 1, File N) which may be broader than a segment index, which may represent the objects at a block level (e.g., File1:block1, File 1:blockN, File N:block 1).

Index updating module 276 may update one or more of the indexes when new events are received by computing device 110. The new events may be added to the event log and may be associated with a new segment or an existing segment. When an event is associated with a new segment index, index updating module 276 may contact index creation module 272 to create a new index. When the event is associated with an existing segment, index updating module 276 may identify the corresponding segment index and update the corresponding segment index to include an identifier for a file system object modified by the new event. Index updating module 276 may also interact with index synthesis module 274 to update the composite index to reflect the new event. When the indexes are probabilistic data structures and index updating module 276 may update the probabilistic data structures in response to an event being added to the plurality of events. The resulting probabilistic data structure may indicate that one or more objects of the plurality of objects are modified by the event added to the plurality of events.

Index updating module 276 may also handle updating the one or more indexes to exclude events that have been applied to the data store. As discussed above, the indexes may utilize a probabilistic data structure (e.g., Bloom filter) that does not support the removal of data from the probabilistic data structure. In this situation, the index updating module 276 may initiate the generation (e.g., regeneration) of one or more indexes to exclude one or more of the events that have been applied to the data store (e.g., flushed to disk). In one example, the index updating module 276 may identify when most or all of the events of a specific segment have been applied to the data store and may initiate the generation of a new composite index that excludes the events from the specific segment.

Index layering module 278 may associate or organize indexes into a layered index. A layered index may include multiple layers having indexes with different durations, scope or granularity. The layered index may have a first layer that includes the composite index discussed above and multiple layers with one or more segment indexes. In one embodiment, each of the layers may have an index with the same scope (e.g., 1000 files) but they may have different granularities or durations. For example, the composite index on the first level may represent a set with a file level granularity and the remaining layers (e.g., layers 2+) may each include an index having a narrower granularity, such as individual blocks of the files. The remaining layers may each include segment indexes corresponding to segments with different durations of time. Layering will be discussed in more detail below. Layering may be advantageous because it may reduce the amount of objects added to each index and therefore reduce or avoid overpopulating an index and increasing the probability of false positives.

The layered index may be a tiered layered index that includes one or more segment indexes on one or more of the layers. When a layer includes multiple segment indexes, each individual segment index may cover or represent a different portion of the composite index or a different type of information or a combination of both. In one embodiment, each of the multiple segment indexes may represent a different portion (e.g., continuous portion or discreet portions) of the scope of the composite index. For example, there may be three segment indexes on a level and each of the segment indexes may cover one third (e.g., 100 objects) of the scope of the composite index (e.g., 300 objects). In another embodiment, each of the multiple segment indexes may represent a different type of information represented by the composite index. For example, there may be two segment indexes on a level and a first index may represent changes to object metadata (e.g., permissions, directories, file names) and a second segment index may represent changes to the object data (e.g., file blocks). Both the first and second segment indexes may have a scope that is the same or similar to composite index and spans the same range of objects (e.g., 300 objects) but may represent different types of data related to the range of objects. In a further embodiment, the multiple segments may represent different portions and different types of information. For example, there may be six segment indexes covering the above three portions of the scope and for each portion, there may be a segment index for metadata and a segment index for data (e.g., data blocks). Data storage computing device 110 may also include a data view component 180 for generating a data view that may be used to identify when data within a data store is out of date. The data view may be part of the in-memory journal and may be used to retrieve data from a data store and event log. Data view component 180 may include data request module 282, index analysis module 284, and data retrieval module 286.

Data request module 282 may receive one or more requests to retrieve data. The requests may be received from a local computing device or a remote computing device and may specify an object within a data store. The object stored in the data store may be associated with one or more events in the event log. These events may change the version of the object within the data store once committed. As such, the version of the object in the data store may be out of date or partially out of date in view of the events in the event log.

Index analysis module 284 may receive a data request and determine whether the data within the data store is out of date. Index analysis module 284 may begin by analyzing the data request to determine identification information for the object. In one example, the identification information may identify a specific file or a specific block within a file. Index analysis module 284 may inspect the composite index (e.g., first layer) using only a portion of the identification information that corresponds to the granularity of the composite index. For example, it may inspect the composite index using only the identification data associated with the file and not the specific block information. Being that the composite index may be implemented using a probabilistic data structure, the inspection may indicate the object is either “definitely not in the set” or “probably in the set.” When the object is “definitely not in the set,” index analysis module 284 may determine that none of the events within the event log alter the object and therefore the version of the object in the data store is up to date.

When the composite index indicates the object is “probably in the set,” the index analysis module 284 may proceed to one or more of the segment indexes in the remaining layers. The segment indexes may be more granular than the composite index and therefore index analysis module 284 may use the specific block of the file when inspecting the segment indexes. The segment index may be a probabilistic data structure that is the same or similar to the composite index and when inspected may indicate the object (e.g., specific block) is either “definitely not in the set” or “probably in the set.” When the object is “definitely not in the set,” index analysis module 284 may perform a similar inspection on one or more of the segment indexes on the remaining layers. The inspection may continue through each of the layers until all of the segment indexes indicate the object is “definitely not within the set,” at which point the index analysis module 284 may determine that the object is not modified by any of the events within any of the segments. This may be in contrast to the composite index indicating that the object was “probably in the set” and may be an example of the composite index providing a false positive.

When one of the segment indexes indicates the object is “probably within the set,” index analysis module 284 may search the corresponding segment for events that alter the specified object. Searching the segment may include scanning or iterating through the events to identify the one or more events that alter the specified object (e.g., file block). In one example, index analysis module may inspect the segment indexes in reverse chronological order so that the more recent segments are inspected first. This may be advantageous because, when an event replaces an object or a portion of an object, there may be no need to search for modifications that predate the event because any prior event may be overwritten by the newer event.

Data retrieval module 286 may use the results of index analysis module 284 to retrieve data for the specified object from the data store, event log or a combination of both. Index analysis module 284 may indicate whether the object or a portion of the object is modified by events within the event log. When the object is not modified by the events within the event log, the data retrieval module 286 may retrieve the data corresponding to the specified object from the data store. When the object is modified by one or more events within the event log, the data retrieval module 286 may analyze the events identified by the index analysis module 284 to retrieve the updated data for the specified object. When a portion of the object is modified by an event and the remaining portion of the object is not modified by an event, the retrieval module may retrieve the portion of data from the event log and the remaining portion from the data store and may return the data combination to fulfill the request.

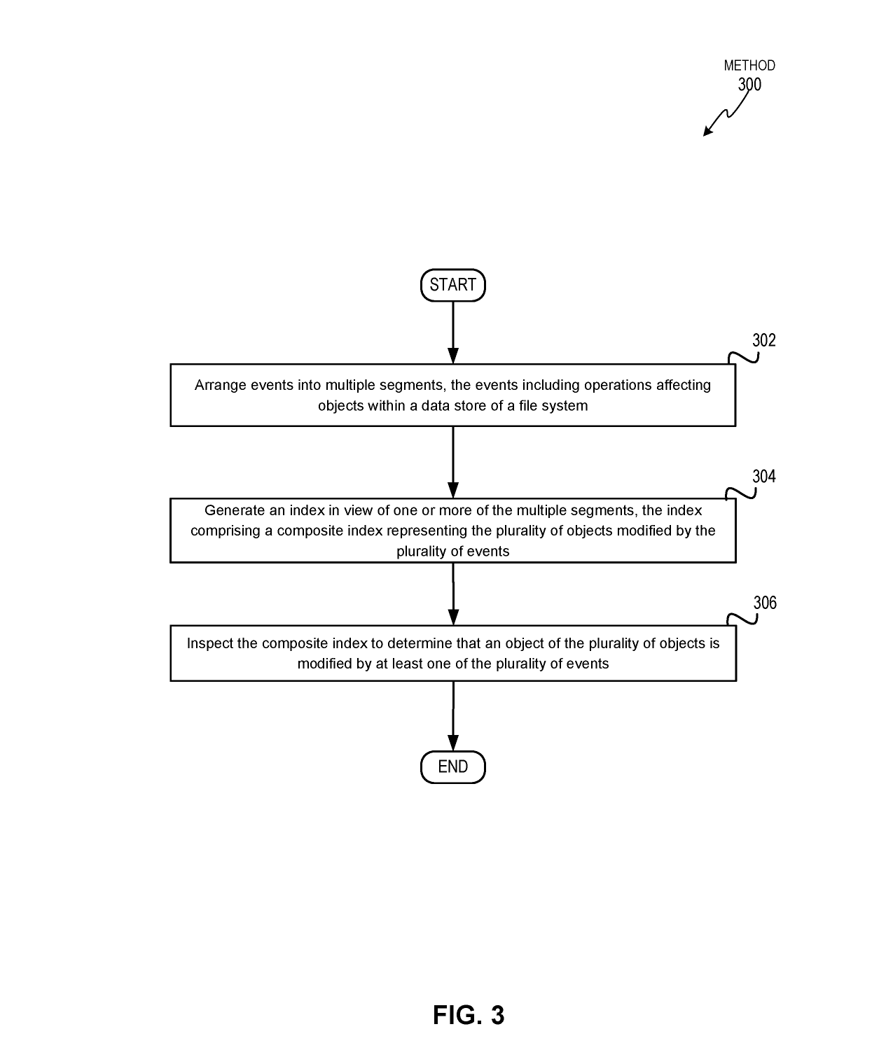

FIG. 3 depicts a flow diagram of one illustrative example of a method 300 for arranging and indexing events to determine which objects are modified by the events. The methods discussed below may be performed by processing device that may comprise hardware (e.g., circuitry, dedicated logic), software (such as is run on a general purpose computer system or a dedicated machine), or a combination of both. The methods and each of their individual functions, routines, subroutines, or operations may be performed by one or more processors of the computer device executing the method. The methods may be performed by processing device of a client device, a server device or a data storage computing device.

Method 300 may begin at block 302, when the processing device arranges a plurality of events into multiple segments. Arranging the events may involve grouping the events into multiple segments in view of timing data. The timing data may indicate when the events are received by the processing device of a server device or when the events are issued by a processing device of a client device modifying the data store.

At block 304, the processing device may generate an index in view of one or more of the multiple segments, the index comprising a composite index that may represent the plurality of objects modified by the plurality of events. The composite index may be generated by generating multiple segment indexes for the multiple segments of an event log and combining the multiple segment indexes to form a composite index. Each of the indexes may be a probabilistic data structure that represents identifiers of the objects that have been modified. The probabilistic data structure may be a Bloom filter or include multiple Bloom filters.

At block 306, the processing device may inspect the composite index to determine that an object of the plurality of objects is modified by at least one of the plurality of events. Inspecting the composite index to determine the object is modified by the at least one of the events may involve analyzing a composite Bloom filter corresponding to events from multiple time periods. The determination may also involve analyzing a first segment Bloom filter to determine whether the file system object is modified during a first time period and analyzing a second segment Bloom filter to determine whether the file system object is modified during a second time period. In response to completing the operations of block 308, the method may terminate.

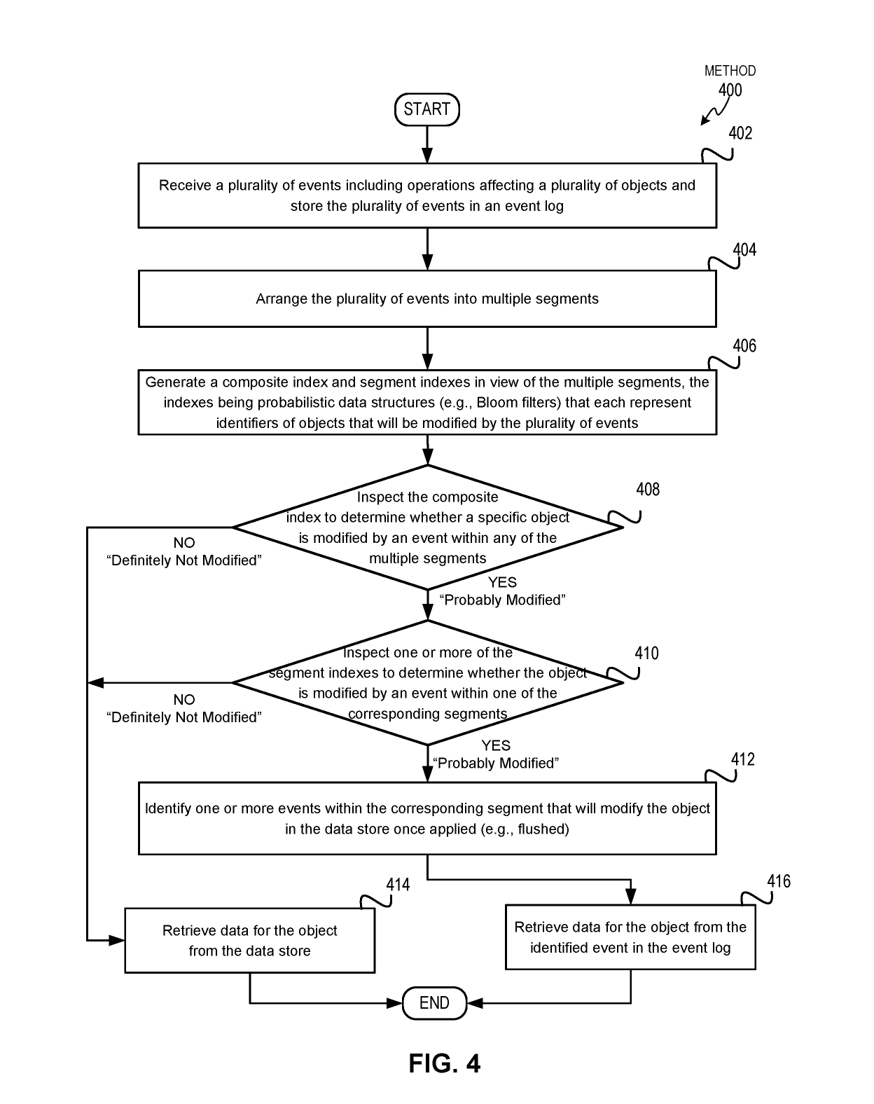

FIG. 4 depicts a flow diagram of one illustrative example of a method 400 for receiving events and generating multiple indexes, which may be used when retrieving data for the objects from a file system's datastore and event log. Method 400 may begin at block 402, when the processing device receives a plurality of events including operations affecting a plurality of objects and stores the plurality of events in an event log. The operations may be file system operations and the plurality of objects may be file system objects affected by the file system operations. The events may be stored to an event log without being run and the event log may include multiple log files. A first log file may be a consolidated log file that includes an entry for each event. The entry may include a portion of an event and a reference to a second log file comprising a remaining portion of the event. In one example, the events may be received by a computing device as an event stream from a computing device over a network and the events may include file system operations that were previously performed at another computing device.

At block 404, the processing device may arrange a plurality of events into multiple segments. Arranging the events may involve grouping the events into multiple segments in view of timing data and may be similar to block 302 of FIG. 3. In one example, the multiple segments may include a first segment of an event log and a second segment of the event log. The first segment may include a portion of the plurality of events received by a computing device during a first time period and the second segment may include a portion of the plurality of events received by the computing device during a second time period.

At block 406, the processing device may generate a composite index and segment indexes in view of the multiple segments. The indexes may be probabilistic data structures (e.g., Bloom filters) that each represent identifiers of the objects that will be modified by the plurality of events. In one example, the index may be a layered index comprising multiple indexes at different layers. An index at a first layer may be the composite index, which may be less granular and represent a larger duration of time then a segment index at a second layer. The multiple indexes of the layered index may be Bloom filters and the first index may be a composite Bloom filter comprising a file level granularity and the second index may be a segment Bloom filter comprising a file block granularity. The layered index may also include a segment index at a third layer and the segment indexes at the second and third layer may correspond to events from different time periods but have the same or similar scope and granularity.

At block 408, the processing device may inspect the composite index to determine whether a specific object of the plurality of objects is modified by at least one event within any of the multiple segments. The determination may involve analyzing a top layer (e.g., broadest level) of a layered index. For example, it may involve analyzing a composite Bloom filter at one layer to determine whether the file system object is modified during any of the time periods (e.g., segments). When the processing device determines that the composite index indicates the object is “definitely not modified” by any of the events, it may proceed to block 414 to retrieve the data for the object from the data store. When the processing device determines that the composite index indicates the object is “probably modified” by at least one of the events, it may proceed to block 410.

At block 410, the processing device may inspect one or more of the segment indexes to determine whether the object is modified by an event within one of the corresponding segments. The determination may involve analyzing one or more of the other indexes at one or more of the other layers. For example, it may involve analyzing a first segment bloom filter at one layer (e.g., layer two) to determine whether the file system object is modified during a first time period and analyzing a second segment bloom filter at a different layer (e.g., layer three) to determine whether the file system object is modified during a second time period. When the processing device determines that all of the segment indexes indicate the object is “definitely not modified” by any of the events, it may proceed to block 414 to retrieve the data for the object from the data store. When the processing device determines that at least one of the segment indexes indicate the object is “probably modified” by at least one of the events, it may proceed to block 412.

At block 412, the processing device may identify one or more events within the corresponding segment that will modify the object in the data store once applied (e.g., flushed). In one example, this may involve iterating or searching through the corresponding segment of the event log to identify the one or more events that are associated with the object. Once an event that modifies the object is identified, the method may proceed to block 416.

At block 416, the processing device may retrieve data for the object from the identified event in the event log. The one or more events may include modifications to the object. In one example, the processing device may retrieve data for the object from the data store and at least one of the plurality of events in the event log. This may occur when the index indicates a first portion of the object (e.g., file blocks A and B) was changed by one of the events and a second portion of the object (e.g., file blocks C and D) remained unchanged by the events. In response, the processing device may gather the first portion of the object from one or more events within the file system's event log and gather the second portion of the object from the file system's data store (e.g., disk storage). In response to completing the operations of block 416, the method may terminate.

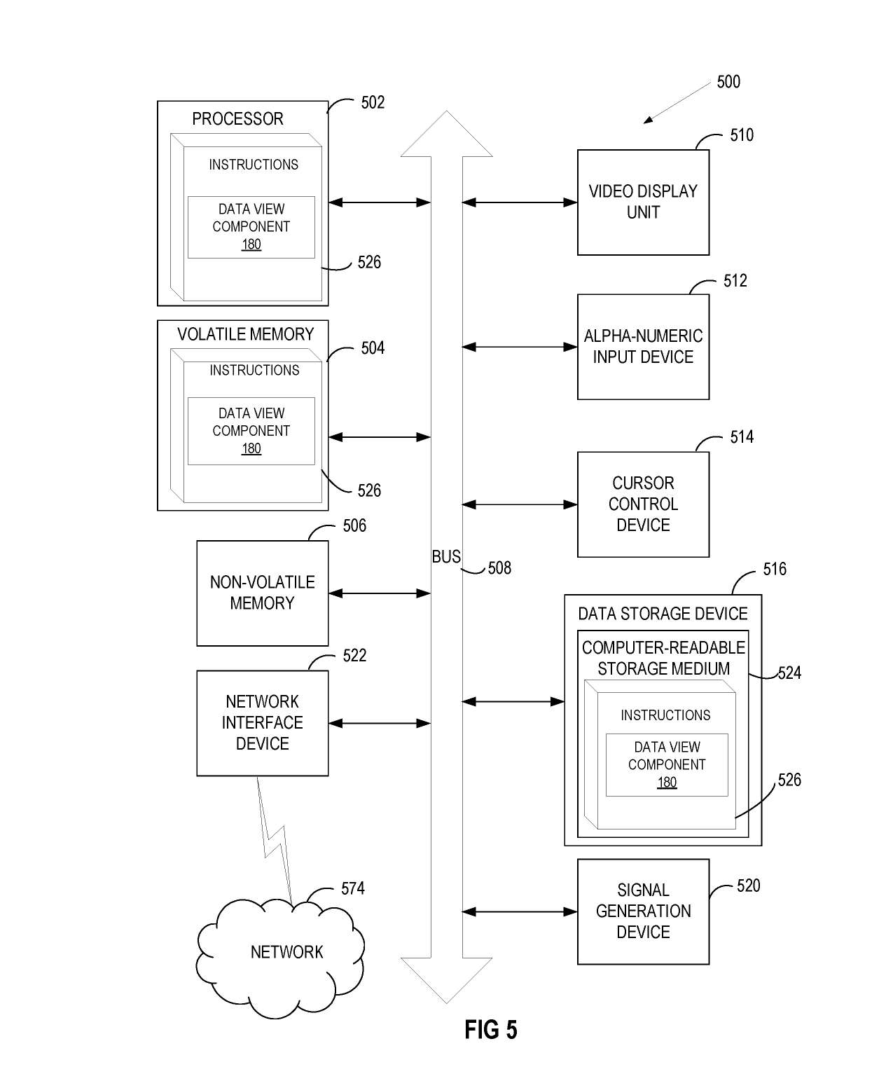

FIG. 5 depicts a block diagram of a computer system operating in accordance with one or more aspects of the present disclosure. In various illustrative examples, computer system 500 may correspond to example system architecture 100 of FIG. 1.

In certain implementations, computer system 500 may be connected (e.g., via a network, such as a Local Area Network (LAN), an intranet, an extranet, or the Internet) to other computer systems. Computer system 500 may operate in the capacity of a server or a client computer in a client-server environment, or as a peer computer in a peer-to-peer or distributed network environment. Computer system 500 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 may include a processor 502, a volatile memory 504 (e.g., random access memory (RAM)), a non-volatile memory 506 (e.g., read-only memory (ROM) or electrically-erasable programmable ROM (EEPROM)), and a data storage device 516, which may communicate with each other via a bus 508.

Processor 502 may be provided by one or more processing devices such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 500 may further include a network interface device 522. Computer system 500 also may include a video display unit 510 (e.g., an LCD), an alphanumeric input device 512 (e.g., a keyboard), a cursor control device 514 (e.g., a mouse), and a signal generation device 520.

Data storage device 516 may include a non-transitory computer-readable storage medium 524 on which may store instructions 526 encoding any one or more of the methods or functions described herein, including instructions encoding event log component 160 (not shown), index component 170 (not shown) or data view component 180 of FIG. 1 implementing methods 300 or 400.

Instructions 526 may also reside, completely or partially, within volatile memory 504 and/or within processor 502 during execution thereof by computer system 500, hence, volatile memory 504 and processor 502 may also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

Unless specifically stated otherwise, terms such as “receiving,” “transmitting,” “arranging,” “combining,” “generating,” “inspecting,” “analyzing,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not necessarily have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 300 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
arranging a plurality of events into multiple segments, the plurality of events comprising operations affecting a plurality of objects within a data store of a file system;
generating multiple indexes in view of one or more of the multiple segments, the indexes comprising a composite index representing the plurality of objects modified by the plurality of events; and
inspecting the composite index to determine that an object of the plurality of objects is modified by at least one of the plurality of events.

2. The method of claim 1, wherein the multiple indexes comprise multiple probabilistic data structures that each represent identifiers of the objects that have been modified, the multiple probabilistic data structures being Bloom filters.

3. The method of claim 1, further comprising retrieving data for the object from the data store and the at least one of the plurality of events.

4. The method of claim 1, wherein the operations are file system operations and the plurality of objects are file system objects affected by the file system operations.

5. The method of claim 1, wherein the multiple segments comprise a first segment of an event log and a second segment of the event log, the first segment comprising a portion of the plurality of events received by a computing device during a first time period and the second segment comprising a portion of the plurality of events received by the computing device during a second time period.

6. The method of claim 1, wherein generating multiple indexes comprises generating the composite index by:
generating multiple segment indexes for the multiple segments of an event log; and
combining the multiple segment indexes to form the composite index.

7. The method of claim 1, wherein inspecting the composite index to determine the object is modified by the at least one of the plurality of events comprises:
analyzing a composite Bloom filter corresponding to events from multiple time periods;
analyzing a first segment Bloom filter to determine whether the file system object is modified during a first time period; and
analyzing a second segment Bloom filter to determine whether the file system object is modified during a second time period, the second time period preceding the first time period.

8. The method of claim 1, wherein the multiple indexes are a layered index comprising indexes at different layers, wherein an index at a first layer is the composite index and an index at the second layer is a segment index, the composite index being less granular and representing a larger duration of time then the segment index.

9. The method of claim 8, wherein the multiple indexes of the layered index are Bloom filters and the first index is a composite Bloom filter comprising a file level granularity and the second index comprises a segment Bloom filter comprising a file block granularity.

10. The method of claim 8, wherein the layered index further comprise a segment index at a third layer, wherein the segment index at the second layer and the segment index at the third layer correspond to events from different time periods and have the same scope and granularity.

11. The method of claim 1, further comprising
receiving the plurality of events from a computing device over a network; and
storing the plurality of events comprising operations in an event log prior to running the operations.

12. The method of claim 1, wherein the events comprise file system operations previously performed by a first computing device and being received by a second computing device as an event stream.

13. The method of claim 1, wherein arranging the plurality of events comprises grouping the plurality of events into the multiple segments in view of timing data, the timing data indicating at least one of: times the events are issued by a client device, times the events are applied by a first computing device to a first replica; times the events are received by a second computing device having a second replica.

14. A system comprising:
a memory; and
a processing device operatively coupled to the memory, the processing device to:
arrange a plurality of events into multiple segments, the plurality of events comprising operations affecting a plurality of objects within a data store of a file system;
generate multiple indexes in view of one or more of the multiple segments, the indexes comprising a composite index representing the plurality of objects modified by the plurality of events; and
inspect the composite index to determine that an object of the plurality of objects is modified by at least one of the plurality of events.

15. The system of claim 14, wherein the multiple indexes comprise a probabilistic data structure that represents identifiers of the objects that have been modified.

16. The system of claim 14, wherein the index comprises multiple Bloom filters.

17. A non-transitory machine-readable storage medium storing instructions that cause a processing device to:
arrange a plurality of events into multiple segments, the plurality of events comprising operations affecting a plurality of objects within a data store of a file system;
generate multiple indexes in view of one or more of the multiple segments, the indexes comprising a probabilistic data structure that represents the plurality of objects modified by the plurality of events; and
update the probabilistic data structure in response to an event being added to the plurality of events, the probabilistic data structure to indicate that an object of the plurality of objects is modified by the event added to the plurality of events.

18. The non-transitory machine-readable storage medium of claim 17, wherein the probabilistic data structure represents identifiers of the plurality of objects modified by the plurality of events.

19. The non-transitory machine-readable storage medium of claim 17, wherein the multiple indexes comprise multiple Bloom filters, wherein each of the multiple bloom filters support an addition of an identifier without supporting a removal of the identifier.

20. The non-transitory machine-readable storage medium of claim 17, wherein the probabilistic data structure is regenerated to exclude one or more of the plurality of events that are applied to the data store.
